(19) United States
(12) Patent Application Publication
(10) Pub. No.: US 2006/0133488 A1
(43) Pub. Date: Jun. 22, 2006

(54) Method for encoding and decoding video signal

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/293,130

(22) Filed: Dec. 5, 2005

Related U.S. Application Data
(60) Provisional application No. 60/632,991, filed on Dec. 6, 2004.

(30) Foreign Application Priority Data
Jun. 10, 2005 (KR) 10-2005-0049652

(51) Int. Cl. H04N 7/12; H04N 11/04; H04B 1/66; H04N 11/02

(52) U.S. Cl. 375/240.12; 375/240.24

(57) ABSTRACT

A method for encoding and decoding a video signal in a scalable Motion Compensated Temporal Filtering (MCTF) scheme is provided. A video signal is encoded by adaptively weighting reference pictures of a current frame based on temporal positions of the reference pictures relative to the current frame in MCTF prediction and update procedures, and such encoded video signal is decoded accordingly. Efficient weighting of reference pictures based on their temporal positions in the prediction and update procedures improves the compression efficiency of the video signal.

### PRIORITY INFORMATION

This application claims priority under 35 U.S.C. §119 on Korean Patent Application No. 10-2005-0049652, filed on Jun. 10, 2005, the entire contents of which are hereby incorporated by reference.

This application also claims priority under 35 U.S.C. §119 on U.S. Provisional Application No. 60/632,991, filed on Dec. 6, 2004; the entire contents of which are hereby incorporated by reference.

### BACKGROUND OF THE INVENTION

1. Field of the Invention

The present invention relates to a method for encoding and decoding a video signal, and more particularly to a method for encoding and decoding a video signal in which adaptive weights based on temporal positions of pictures in the video signal are used in their prediction and update procedures of Motion Compensated Temporal Filtering (MCTF).

2. Description of the Related Art

It is difficult to allocate high bandwidth, required for TV signals, to digital video signals wirelessly transmitted and received by mobile phones and notebook computers, which are widely used, and by mobile TVs and handheld PCs, which it is believed will come into widespread use in the future. Thus, video compression standards for use with mobile devices must have high video signal compression efficiencies.

Such mobile devices have a variety of processing and presentation capabilities so that a variety of compressed video data forms must be prepared. This indicates that a variety of qualities of video data having combinations of a number of variables such as the number of frames transmitted per second, resolution, and the number of bits per pixel must be provided for a single video source. This imposes a great burden on content providers.

Because of these facts, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding and encoding processes, which causes some time delay in providing the requested data to the mobile device. The transcoding procedure also requires complex hardware and algorithms to cope with the wide variety of target encoding formats.

The Scalable Video Codec (SVC) has been developed in an attempt to overcome these problems. This scheme encodes video into a sequence of pictures with the highest image quality while ensuring that part of the encoded picture sequence (specifically, a partial sequence of frames intermittently selected from the total sequence of frames) can be decoded to video with a certain level of image quality.

Motion Compensated Temporal Filtering (MCTF) is an encoding scheme that has been suggested for use in the scalable video codec. However, the MCTF scheme requires a high compression efficiency (i.e., a high coding efficiency) for reducing the number of bits transmitted per second since the MCTF scheme is likely to be applied to transmission environments such as a mobile communication environment where bandwidth is limited.

FIG. 1 illustrates how a video signal is encoded in a general MCTF scheme.

In MCTF, a video signal is composed of a sequence of pictures at specific time intervals. For a given odd (or even) picture, a reference picture is selected from adjacent even (or odd) pictures to the left and right sides of the given picture. A prediction operation is performed to calculate an image difference or error (also referred to as a “residual”) of the given picture from the reference picture and produce an ‘H’ picture having the image error. The image error of the H picture is added to the reference picture used to obtain the image error. This operation is referred to as an update operation, and a picture produced by this update operation is referred to as an ‘L’ picture.

Such prediction and update operations are performed for a Group Of Pictures (GOP) (for example, 8 pictures) to obtain 4H pictures and 4 L pictures. The prediction and update operations are repeated for the 4 L pictures to obtain 2H pictures and 2 L pictures. The prediction and update operations are repeated until one H picture and one L picture are obtained. Such a procedure is referred to as Temporal Decomposition (TD) and each step of this procedure is referred to as an MCTF or temporal decomposition level. All H pictures obtained by the prediction operations at all levels and one L picture obtained by the update operation at the last level are transmitted when the temporal decomposition procedure is completed for a single GOP.

The procedure for decoding a video frame encoded in the MCTF scheme is performed in the opposite order to that of the encoding procedure of FIG. 1. As described above, scalable encoding such as MCTF allows video to be viewed even with a partial sequence of pictures selected from the total sequence of pictures. Thus, when decoding is performed, the extent of decoding can be adjusted based on the transfer rate of a transmission channel, i.e., the amount of video data received per unit time. Typically, this adjustment is made in units of GOPs, and reduces the level of Temporal Composition (TC), which is the inverse of temporal decomposition, when the amount of information is insufficient and increases the level of temporal composition when the amount of information is sufficient.

FIG. 2 illustrates how H and L pictures are produced using weights in prediction and update procedures of a general MCTF encoding method.

A video signal s[x,t] with a space coordinate x=[x,y]^{T} and a time coordinate t is decomposed into H pictures h[x,t] having high frequency components and L pictures l[x,t] having low frequency components with a time resolution reduced by half. The H and L pictures h[x,t] and l[x,t] are expressed by the following equations.
h[x,t]=s[x,2t+1]−(w₀·s[x+m_{P0}(x),2t−2r_{P0}(x)]+w₁s[x+m_{P1}(x),2t+2r_{P1}(x)+2])
l[x,t]=s[x,2t]+(w₀·h[x+m_{U0}(x),t+r_{U0}(x)]+w₁·h[x+m_{U1}(x),t−r_{U1}(x)−1])>>1,

where “r(>=0)” denotes indices indicating reference pictures used for motion compensation in prediction and update procedures and “m” denotes motion vectors used in prediction and update procedures. In addition, “r_{P0}” and “r_{P1}” denote indices indicating reference pictures 0 and 1 used in the prediction procedure, and “r_{U0}” and “r_{U1}” denote indices indicating reference pictures 0 and 1 used in the update procedure.

In prediction and update procedures of 5/3 tap MCTF encoding, each macroblock can refer to one or more reference pictures. For example, when two reference pictures are referred to, weights (w₁=½and w₀=½) are used in the prediction procedure, and weights w₀ and w₁ for use in the update procedure are determined based on two factors, i.e., the number of samples (pixels) connected between a 4×4 block to be updated and two corresponding macroblocks in the two reference pictures and the energy of signals of the two macroblocks predicted for the 4×4 block.

For example, when only one reference picture is present, one weight w₀ (or w₁) for use in the prediction procedure is “1” and the other weight w₁ (or w₀) is “0”, and one weight w₀ (or w₁) for use in the update procedure is determined in the same manner as described above and the other weight w₁ (or w₀) is 0.

In FIG. 2, weights (w₁=1 and w₀=0) are used for a block A since the block A refers to only one reference picture in the prediction procedure, and weights (w₁=½and w₀=½) are used for blocks B and C since each refers to two reference pictures in the prediction procedure. Since a block D refers to two blocks A and C in two pictures in the update procedure, weights w₁ and w₀ for the block D are determined based on both the number of samples (pixels) connected between the block D and the two blocks A and C and the energy of signals of the two blocks A and C predicted for the block D.

In the conventional MCTF prediction procedure, two reference pictures are weighted by the same value regardless of temporal positions of the reference pictures. However, using the same weight for two reference pictures may not contribute to increasing the MCTF compression or coding efficiency, and an efficient method for weighting reference pictures has not yet been suggested.

### SUMMARY OF THE INVENTION

Therefore, the present invention has been made in view of the above problems, and it is an object of the present invention to provide a method for encoding a video signal, which efficiently weights reference pictures in MCTF prediction and update procedures to increase coding efficiency, and a method for decoding a video signal encoded in the encoding method.

In accordance with one aspect of the present invention, the above and other objects can be accomplished by the provision of a method for encoding a video frame sequence divided into a first sub-sequence including frames, which are to have image difference values, and a second sub-sequence including frames to which the image difference values are to be added, the method comprising the steps of a) searching frames temporally adjacent to an arbitrary frame belonging to the first sub-sequence for reference blocks of a first image block included in the arbitrary frame, adjusting pixel values of the reference blocks by weights calculated based on temporal positions of the reference blocks relative to the first image block, and obtaining an image difference of the first image block from the reference blocks having the adjusted pixel values; and b) searching frames in the first sub-sequence for target blocks whose image differences have been obtained using, as a reference block, a second image block included in an arbitrary frame belonging to the second sub-sequence, adjusting the image differences of the target blocks, which have been obtained at the step a), by both predetermined weights and new weights calculated based on temporal positions of the target blocks relative to the second image block, and adding the adjusted image differences to the second image block.

Preferably, the reference blocks are present in frames belonging to the second sub-sequence and temporally adjacent to the arbitrary frame belonging to the first sub-sequence. Preferably, the number of the reference blocks found at the step a) is two or less and the number of the target blocks found at the step b) is two or less.

Preferably, the weights at the step a) are calculated to be inversely proportional to temporal distances of the reference blocks from the first image block, and the new weights at the step b) are calculated by multiplying the predetermined weights by values calculated to be inversely proportional to temporal distances of the target blocks from the second image block. Preferably, the predetermined weights are calculated based on both the number of samples connected between the second image block and the target blocks and energy of the target blocks.

In accordance with another aspect of the present invention, there is provided a method for decoding a first frame sequence having image difference values and a second frame sequence into a video signal, the method comprising the steps of a) searching frames in the first frame sequence for target blocks whose image differences have been obtained using, as a reference block, a first image block included in an arbitrary frame belonging to the second frame sequence, adjusting the image differences of the found target blocks by predetermined weights and new weights calculated based on temporal positions of the target blocks relative to the first image block, and subtracting the adjusted image difference from the first image block; and b) searching frames in the second frame sequence for reference blocks of a second image block included in an arbitrary frame belonging to the first frame sequence, adjusting pixel values of the reference blocks by weights calculated based on temporal positions of the reference blocks relative to the second image block, and adding the reference blocks having the adjusted pixel values to the second image block.

Preferably, the new weights at the step a) are calculated by multiplying the predetermined weights by values calculated to be inversely proportional to temporal distances of the target blocks from the first image block, and the weights at the step b) are calculated to be inversely proportional to temporal distances of the reference blocks from the second image block. Preferably, the predetermined weights are calculated based on both the number of samples connected between the first image block and the target blocks and energy of the target blocks.

Preferably, the reference blocks of the second image block are specified based on information included in a header of the second image block.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates how a video signal is encoded in a general 5/3 tap MCTF encoding method;

FIG. 2 illustrates how H and L pictures are produced using weights in prediction and update procedures of a general MCTF encoding method;

FIG. 3 is a block diagram of a video signal encoding apparatus to which a scalable video signal coding method according to the present invention is applied;

FIG. 4 illustrates a structure for temporal decomposition of a video signal at a temporal decomposition level;

FIG. 5 illustrates how H and L frames are produced using adaptive weights in predication and update procedures of an MCTF encoding method according to the present invention;

FIG. 6 is a block diagram of an apparatus for decoding a data stream encoded by the apparatus of FIG. 3; and

FIG. 7 illustrates a structure for temporal composition (TC) of H and L frame sequences of TC level N into an L frame sequence of TC level N−1.

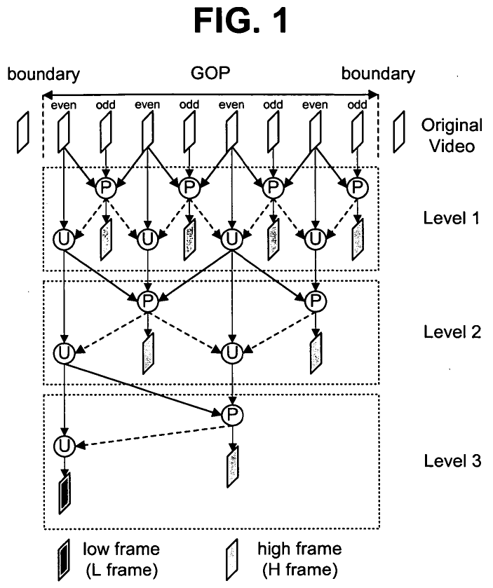

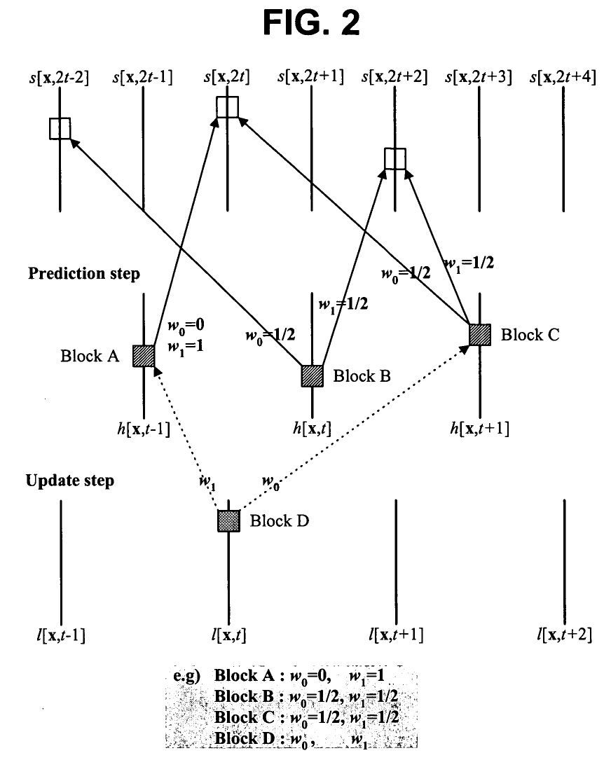

### DESCRIPTION OF THE PREFERRED EMBODIMENTS

Preferred embodiments of the present invention will now be described in detail with reference to the accompanying drawings.

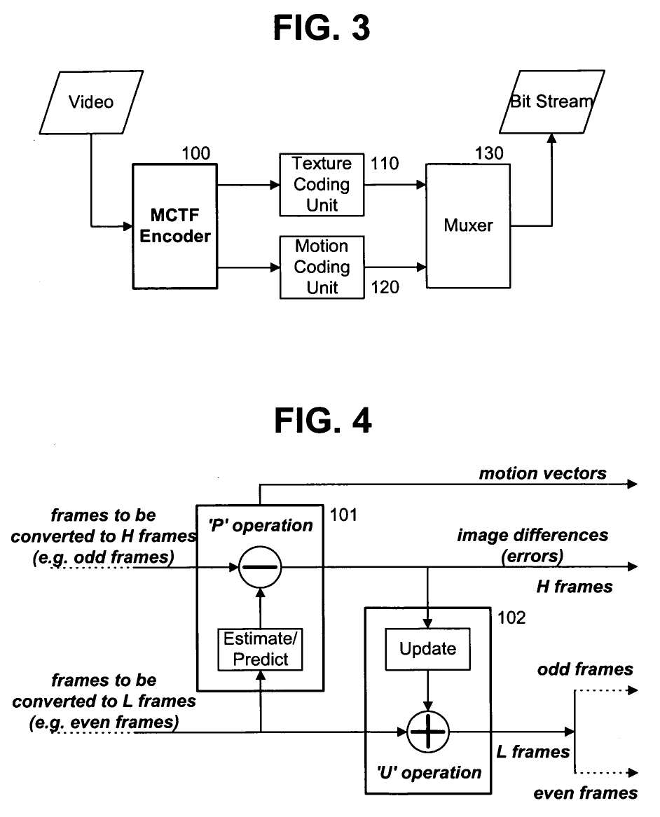

FIG. 3 is a block diagram of a video signal encoding apparatus to which a scalable video signal coding method according to the present invention is applied.

The video signal encoding apparatus shown in FIG. 3 comprises an MCTF encoder 100, a texture coding unit 110, a motion coding unit 120, and a muxer (or multiplexer) 130. The MCTF encoder 100 encodes an input video signal in units of macroblocks according to an MCTF scheme, and generates suitable management information. The texture coding unit 110 converts data of encoded macroblocks into a compressed bitstream. The motion coding unit 120 codes motion vectors of image blocks obtained by the MCTF encoder 100 into a compressed bitstream according to a specified scheme. The muxer 130 encapsulates the output data of the texture coding unit 110 and the output vector data of the motion coding unit 120 into a predetermined format. The muxer 130 multiplexes the encapsulated data into a predetermined transmission format and outputs a data stream.

The MCTF encoder 100 performs a prediction operation on each macroblock in a video frame (or picture) by subtracting a reference block, found by motion estimation, from the macroblock and an update operation by adding an image difference between the reference block and the macroblock to the reference block. FIG. 4 is a block diagram of part of a filter for carrying out these operations.

The MCTF encoder 100 separates an input video frame sequence into frames, which are to have error values, and frames, to which the error values are to be added, for example, into odd and even frames. The MCTF encoder 100 performs prediction and update operations on the separated frames over a number of MCTF levels. FIG. 4 shows elements associated with estimation/prediction and update operations at one of the MCTF levels.

The elements of FIG. 4 include an estimator/predictor 101 and an updater 102. Through motion estimation, the estimator/predictor 101 searches for a reference block of each macroblock of a frame (for example, an odd frame), which is to have residual data, in an even frame prior to or subsequent to the frame, and then performs a prediction operation to calculate an image difference (i.e., a pixel-to-pixel difference) of the macroblock from the reference block and a motion vector from the macroblock to the reference block. The updater 102 performs an update operation on a frame (for example, an even frame) including the reference block of the macroblock by normalizing the calculated image difference of the macroblock from the reference block and adding the normalized value to the reference block.

The operation carried out by the estimator/predictor 101 is referred to as a ‘P’ operation, and a frame produced by the ‘P’ operation is referred to as an ‘H’ frame. Residual data present in the ‘H’ frame reflects high frequency components of the video signal. The operation carried out by the updater 102 is referred to as a ‘U’ operation, and a frame produced by the ‘U’ operation is referred to as an ‘L’ frame. The ‘L’ frame is a low-pass subband picture.

The estimator/predictor 101 and the updater 102 of FIG. 4 may perform their operations on a plurality of slices, which are produced by dividing a single frame, simultaneously and in parallel, instead of performing their operations in units of frames. In the following description of the embodiments, the term ‘frame’ is used in a broad sense to include a ‘slice’, provided that replacement of the term ‘frame’ with the term ‘slice’ is technically equivalent.

More specifically, the estimator/predictor 101 divides each input video frame or each odd one of the L frames obtained at the previous MCTF level into macroblocks of a predetermined size. The estimator/predictor 101 then searches for a block, whose image is most similar to that of each divided macroblock, in an even frame at the same temporal decomposition level, and produces a predictive image of each divided macroblock and obtains a motion vector thereof based on the found block.

A block having the most similar image to a target block has the smallest image difference from the target block. The image difference of two blocks is defined, for example, as the sum or average of pixel-to-pixel differences of the two blocks. Of blocks having a predetermined threshold pixel-to-pixel difference sum (or average) or less from the target block, a block(s) having the smallest difference sum (or average) is referred to as a reference block(s).

If a reference block is found, the estimator/predictor 101 obtains a motion vector from the current macroblock to the reference block and transmits the motion vector to the motion coding unit 120. If one reference block is found in a frame, the estimator/predictor 101 calculates errors (i.e., differences) of pixel values of the current macroblock from pixel values of the reference block and codes the calculated errors in the current macroblock. If a plurality of reference blocks is found in a plurality of frames, the estimator/predictor 101 calculates errors (i.e., differences) of pixel values of the current macroblock from the respective sums of pixel values of the reference blocks, which have been adjusted by weights calculated based on the temporal positions of the reference blocks relative to the current macroblock, and codes the calculated errors in the current macroblock. Then, the estimator/predictor 101 inserts a block mode type of the macroblock, a reference index indicating a frame having the reference block, and other various information, which may be used during decoding, in a header area of the macroblock.

The estimator/predictor 101 performs the above procedure for all macroblocks in the frame to complete an H frame which is a predictive image of the frame. The estimator/predictor 101 performs the above procedure for all input video frames or all odd ones of the L frames obtained at the previous MCTF level to complete H frames which are predictive images of the input frames.

As described above, the updater 102 adds an image difference of each macroblock in an H frame produced by the estimator/predictor 101 to an L frame having its reference block, which is an input video frame or an even one of the L frames obtained at the previous MCTF level.

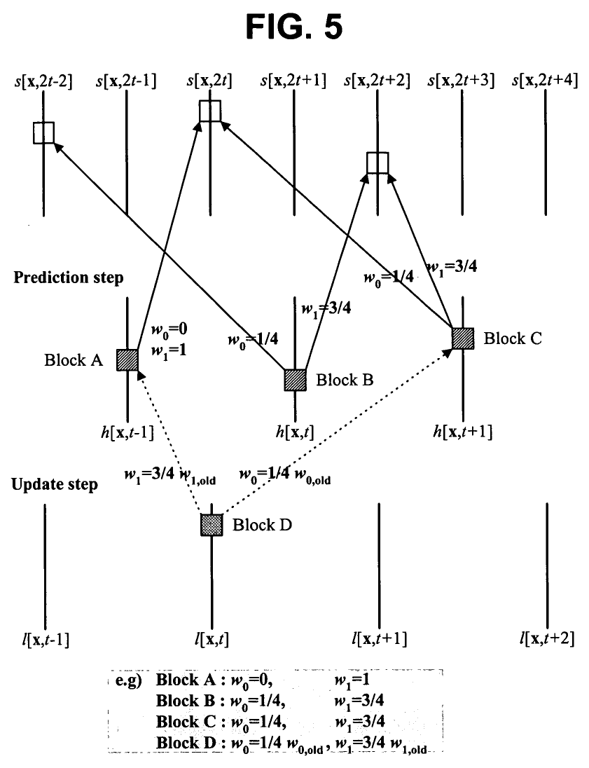

FIG. 5 illustrates how H and L frames are produced using adaptive weights in predication and update procedures of an MCTF encoding method according to the present invention.

If two reference frames (blocks) are referred to in the prediction and update procedures in which a video signal is temporally decomposed, weights of reference blocks 0 and 1 are determined based on the temporal positions of a frame including the reference block 0 and a frame including the reference block 1 relative to the current frame, according to the present invention.

It can be assumed that the nearer two frames are to each other, the more highly correlated they are. Thus, applying adaptive weights to reference blocks (or frames) based on their temporal positions can predict signals more accurately than when the same weight is applied.

In the update procedure, a predicted signal (corresponding to residual data obtained in the prediction procedure) of the H frame having high frequency components is added to an original frame having low frequency components to obtain an L frame having low frequency components. If two H frames having high frequency components use the original frame having low frequency components as their reference frame, the original frame makes a greater contribution to one of the two H frames, which is nearer to the original frame, than to the other H frame, which is farther from the original frame, so that a weight used for the nearer H frame when producing an L frame having low frequency components corresponding to the original frame is calculated to be higher than a weight used for the other H frame based on their temporal positions relative to the original frame.

A Picture Order Count (POC) of a picture (or frame) specifies its temporal position, so that POCs of two frames can be used to calculate the temporal distance between the two frames.

Weights in the prediction procedure can be calculated by the following equation.

$${w}_{o} = \frac{{ⅆ}_{1}}{{ⅆ}_{0} + {ⅆ}_{1}} , {w}_{1} = \frac{{ⅆ}_{0}}{{ⅆ}_{0} + {ⅆ}_{1}} ,$$

where d₀=|POC(r₀)−POC (current picture)| and d₁=|POC(rᵢ)−POC(current picture)|.

A more detailed description will now be given, with reference to FIG. 5, of how adaptive weights are obtained in the prediction procedure according to the present invention. Weights for a block A are calculated such that w₁=1 and w₀=0 since only one reference frame (or block) s[x,2t] is referred to in the prediction procedure of the block A. Weights for a block B are calculated such that w₀=¼ and w₁=¾ since two reference frames (or blocks) 0 and 1 (s[x,2t−2] and s[x,2t+2]) are referred to in the prediction procedure of the block B, and temporal distances d₀ and d₁ of a frame h[x,t] or s[x,2t+1] including the block B from the two reference frames 0 and 1 (s[x,2t−2] and s[x,2t+2]), each including a reference block of the block B, are 3 and 1. Similarly, weights for a block C are calculated such that w₀=¼ and w₁=¾ since two reference frames (or blocks) 0 and 1 (s[x,2t] and s[x,2t+2]) are referred to in the prediction procedure of the block C, and temporal distances d₀ and d₁ of a frame h[x,t+1] or s[x,2t+3] including the block C from the two reference frames 0 and 1 (s[x,2t] and s[x,2t+2]), each including a reference block of the block C, are 3 and 1.

Weights in the update procedure can be calculated by the following equation.

$${w}_{0} = {w}_{0 , old} \cdot \frac{{ⅆ}_{1}}{{ⅆ}_{0} + {ⅆ}_{1}} , {w}_{1} = {w}_{1 , old} \cdot \frac{{ⅆ}_{0}}{{ⅆ}_{0} + {ⅆ}_{1}} ,$$

where d₀=|POC(r₀)−POC(current picture)| and d₁=|POC(r₁)−POC(current picture)|, and w_{0,old} and W_{1,old} can be calculated by a weight determination method employed in the conventional update procedure.

Weights for a block D present in a low-frequency (or low-pass) frame l[x,t], which is to be obtained in the update procedure, are calculated such that w₀=¼×w_{0,old} and w₁=¾×w_{1,old} since two blocks C and A use, as their reference block, a block corresponding to the block D in an original frame having low frequency components s[x,2t] corresponding to the low-frequency frame l[x,t], and temporal distances d₀ and d₁ of the frame l[x,t] (or s[x,2t]) including the block D from a frame h[x,t−1] (or s[x,2t+3]) including the block C and a frame h[x,t+1] (or s[x,2t−1]) including the block A are 3 and 1. Here, weights w_{0,old} and w_{1,old} can be determined based on the number of samples (pixels) connected between the block D and the two blocks C and A and the energy of signals of the blocks C and A predicted for the block D.

The data stream encoded in the method described above is transmitted by wire or wirelessly to a decoding apparatus or is delivered via recording media. The decoding apparatus reconstructs the original video signal according to the method described below.

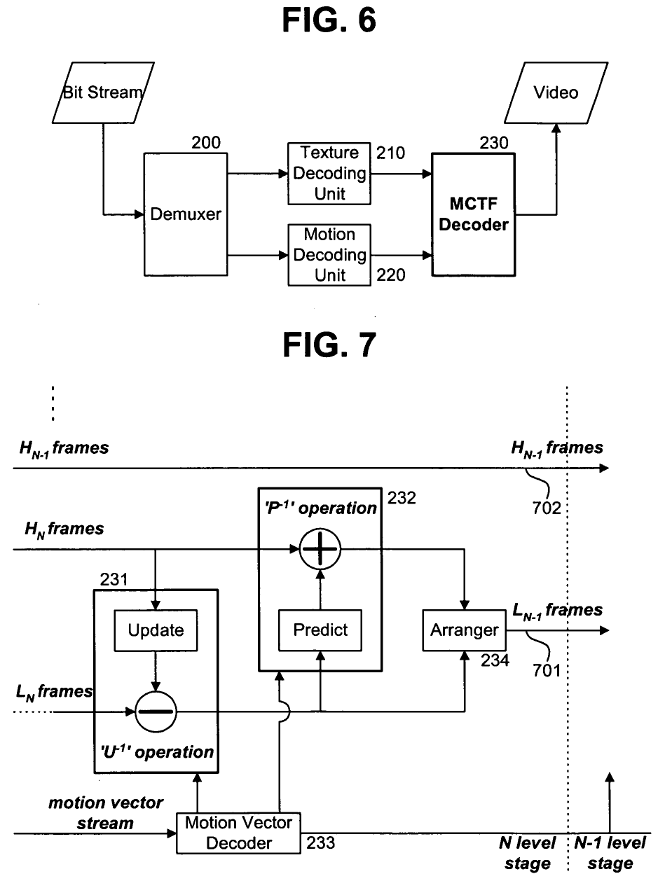

FIG. 6 is a block diagram of an apparatus for decoding a data stream encoded by the apparatus of FIG. 3. The decoding apparatus of FIG. 6 includes a demuxer (or demultiplexer) 200, a texture decoding unit 210, a motion decoding unit 220, and an MCTF decoder 230. The demuxer 200 separates a received data stream into a compressed motion vector stream and a compressed macroblock information stream. The texture decoding unit 210 reconstructs the compressed macroblock information stream to its original uncompressed state. The motion decoding unit 220 reconstructs the compressed motion vector stream to its original uncompressed state. The MCTF decoder 230 converts the uncompressed macroblock information stream and the uncompressed motion vector stream back to an original video signal according to an MCTF scheme.

The MCTF decoder 230 reconstructs an input stream to an original frame sequence. FIG. 7 is a detailed block diagram of main elements of the MCTF decoder 230.

The elements of the MCTF decoder 230 of FIG. 7 perform temporal composition of H and L frame sequences of temporal decomposition level N into an L frame sequence of temporal decomposition level N−1. The elements of FIG. 7 include an inverse updater 231, an inverse predictor 232, a motion vector decoder 233, and an arranger 234. The inverse updater 231 selectively subtracts difference values of pixels of input H frames from corresponding pixel values of input L frames. The inverse predictor 232 reconstructs input H frames to L frames having original images using both the H frames and the above L frames, from which the image differences of the H frames have been subtracted. The motion vector decoder 233 decodes an input motion vector stream into motion vector information of blocks in H frames and provides the motion vector information to an inverse updater 231 and an inverse predictor 232 of each stage. The arranger 234 interleaves the L frames completed by the inverse predictor 232 between the L frames output from the inverse updater 231, thereby producing a normal L frame sequence.

L frames output from the arranger 234 constitute an L frame sequence 701 of level N−1. A next-stage inverse updater and predictor of level N−1 reconstructs the L frame sequence 701 and an input H frame sequence 702 of level N−1 to an L frame sequence. This decoding process is performed the same number of times as the number of MCTF levels employed in the encoding procedure, thereby reconstructing an original video frame sequence.

A reconstruction (temporal composition) procedure at level N, in which received H frames of level N and L frames of level N produced at level N+1 are reconstructed to L frames of level N−1, will now be described in more detail.

For an input L frame of level N, the inverse updater 231 determines all corresponding H frames of level N, whose image differences have been obtained using, as reference blocks, blocks in an original L frame of level N−1 updated to the input L frame of level N at the MCTF encoding procedure, with reference to motion vectors provided from the motion vector decoder 233. The inverse updater 231 then multiplies error values of macroblocks in the corresponding H frames of level N by specific weights and subtracts the error values multiplied by the weights from pixel values of blocks in the input L frame of level N, which correspond to the reference blocks in the original L frame of level N−1, thereby reconstructing an original L frame.

In the conventional inverse update procedure of MCTF decoding, error values of macroblocks in the corresponding H frames are multiplied by weights, calculated by the weight determination method employed in the conventional update procedure of MCTF encoding (i.e., determined based on both the number of samples (pixels) connected between the macroblocks in the corresponding H frames and their reference blocks and the energy of signals of the macroblocks predicted for the reference blocks), and the error values multiplied by the calculated weights are subtracted from pixel values of corresponding blocks in the input L frame.

However, in the inverse update procedure of MCTF decoding according to the present invention, the weights calculated by the conventional method are adjusted based on temporal positions of the corresponding H frames relative to the L frame. For example, if a target block in an input L frame of level N (more strictly, a corresponding block in an original L frame of level N−1 updated to the input L frame of level N in the MCTF encoding procedure) has been used as a reference block to obtain error values of macroblocks of two H frames of level N, i.e., if the target block in the input L frame has been updated using macroblocks in two H frames, weights calculated by the conventional method are adjusted based on temporal positions of the two H frames relative to the input L frame, and the error values of the macroblocks in the two H frames are multiplied respectively by the adjusted weights (i.e., the error values of the macroblocks in the two H frames are weighted differently depending on temporal distances of the two H frames from the input L frame). Then, the error values of the macroblocks in the two H frames, multiplied by the adjusted weights, are subtracted from pixel values of the target block in the input L frame.

Such an inverse update operation is performed for blocks in the current L frame of level N, which have been updated using error values of macroblocks in H frames in the encoding procedure, thereby reconstructing the L frame of level N to an L frame of level N−1.

For a target macroblock in an input H frame, the inverse predictor 232 determines its reference blocks in inverse-updated L frames output from the inverse updater 231 with reference to motion vectors provided from the motion vector decoder 233, and adds pixel values of the reference blocks to difference (error) values of pixels of the target macroblock, thereby reconstructing its original image.

In the conventional inverse prediction procedure of MCTF decoding, pixel values of reference blocks of a target macroblock in an input H frame are weighted by the same value so as to be added to difference values of pixels of the target macroblock.

However, in the inverse prediction procedure of MCTF decoding according to the present invention, pixel values of reference blocks of a target macroblock in an input H frame are weighted based on temporal positions of L frames including the reference blocks relative to the input H frame. For example, if two different L frames have reference blocks of a target macroblock in an input H frame (i.e., if a target macroblock in an input H frame has been predicted using reference blocks in two different L frames), pixel values of the reference blocks are multiplied by weights determined based on temporal positions of the two L frames having the reference blocks relative to the H frame (i.e., the pixel values of the reference blocks in the two L frames are weighted differently depending on temporal distances of the two L frames from the H frame) and the multiplied pixel values are added to difference values of pixels of the target macroblock in the H frame.

Such an inverse prediction operation is performed for all macroblocks in the current H frame to reconstruct the current H frame to an L frame. The arranger 234 alternately arranges L frames reconstructed by the inverse predictor 232 and L frames updated by the inverse updater 231, and outputs such arranged L frames to the next stage.

Although the weight determination method has been described only for the case where reference blocks are present in two frames, weights of reference blocks present in three frames can also be calculated to be inversely proportional to temporal distances of the three frames from the current frame as follows.

$${w}_{0} = \frac{{ⅆ}_{1} {ⅆ}_{2}}{{ⅆ}_{0} {ⅆ}_{1} + {ⅆ}_{1} {ⅆ}_{2} + {ⅆ}_{2} {ⅆ}_{0}} , \\ {w}_{1} = \frac{{ⅆ}_{2} {ⅆ}_{0}}{{ⅆ}_{0} {ⅆ}_{1} + {ⅆ}_{1} {ⅆ}_{2} + {ⅆ}_{2} {ⅆ}_{0}} , \\ {w}_{2} = \frac{{ⅆ}_{0} {ⅆ}_{1}}{{ⅆ}_{0} {ⅆ}_{1} + {ⅆ}_{1} {ⅆ}_{2} + {ⅆ}_{2} {ⅆ}_{0}} ,$$

where d₀=|POC(r₀)−POC(current picture)| and d₁=|POC(r₁)−POC(current picture)| and d₂=|POC(r₂)−POC(current picture)|.

Thus, the adaptive weights in the prediction and update procedures of MCTF encoding and the inverse update and prediction procedures of MCTF decoding according to the present invention can also be applied when reference blocks are present in more than two frames.

The above decoding method reconstructs an MCTF-encoded data stream to a complete video frame sequence. In the case where the prediction and update operations have been performed for a group of pictures (GOP) N times in the MCTF encoding procedure described above, a video frame sequence with the original image quality is obtained if the inverse update and prediction operations are performed N times in the MCTF decoding procedure, whereas a video frame sequence with a lower image quality and at a lower bitrate is obtained if the inverse update and prediction operations are performed less than N times. Accordingly, the decoding apparatus is designed to perform inverse update and prediction operations to the extent suitable for the performance thereof.

The decoding apparatus described above can be incorporated into a mobile communication terminal, a media player, or the like.

As is apparent from the above description, a method for encoding and decoding a video signal according to the present invention efficiently weights reference pictures when encoding/decoding video in a scalable MCTF scheme, thereby increasing the compression efficiency.

Although the preferred embodiments of the present invention have been disclosed for illustrative purposes, those skilled in the art will appreciate that various improvements, modifications, substitutions, and additions are possible, without departing from the scope and spirit of the invention as disclosed in the accompanying claims.

What is claimed is:

1. A method for encoding a video frame sequence divided into a first sub-sequence including frames, which are to have image difference values, and a second sub-sequence including frames to which the image difference values are to be added, the method comprising the steps of:
a) searching frames temporally adjacent to an arbitrary frame belonging to the first sub-sequence for reference blocks of a first image block included in the arbitrary frame, adjusting pixel values of the reference blocks by weights calculated based on temporal positions of the reference blocks relative to the first image block, and obtaining an image difference of the first image block from the reference blocks having the adjusted pixel values; and
b) searching frames in the first sub-sequence for target blocks whose image differences have been obtained using, as a reference block, a second image block included in an arbitrary frame belonging to the second sub-sequence, adjusting the image differences of the target blocks, which have been obtained at the step a), by both predetermined weights and new weights calculated based on temporal positions of the target blocks relative to the second image block, and adding the adjusted image differences to the second image block.

2. The method according to claim 1, wherein the reference blocks are present in frames belonging to the second sub-sequence and temporally adjacent to the arbitrary frame belonging to the first sub-sequence.

3. The method according to claim 1, wherein the number of the reference blocks found at the step a) is two or less and the number of the target blocks found at the step b) is two or less.

4. The method according to claim 1, wherein the weights at the step a) are calculated to be inversely proportional to temporal distances of the reference blocks from the first image block, and the new weights at the step b) are calculated by multiplying the predetermined weights by values calculated to be inversely proportional to temporal distances of the target blocks from the second image block.

5. The method according to claim 1, wherein the predetermined weights are calculated based on both the number of samples connected between the second image block and the target blocks and energy of the target blocks.

6. A method for decoding a first frame sequence having image difference values and a second frame sequence into a video signal, the method comprising the steps of:
a) searching frames in the first frame sequence for target blocks whose image differences have been obtained using, as a reference block, a first image block included in an arbitrary frame belonging to the second frame sequence, adjusting the image differences of the found target blocks by predetermined weights and new weights calculated based on temporal positions of the target blocks relative to the first image block, and subtracting the adjusted image difference from the first image block; and
b) searching frames in the second frame sequence for reference blocks of a second image block included in an arbitrary frame belonging to the first frame sequence, adjusting pixel values of the reference blocks by weights calculated based on temporal positions of the reference blocks relative to the second image block, and adding the reference blocks having the adjusted pixel values to the second image block.

7. The method according to claim 6, wherein the new weights at the step a) are calculated by multiplying the predetermined weights by values calculated to be inversely proportional to temporal distances of the target blocks from the first image block, and the weights at the step b) are calculated to be inversely proportional to temporal distances of the reference blocks from the second image block.

8. The method according to claim 6, wherein the predetermined weights are calculated based on both the number of samples connected between the first image block and the target blocks and energy of the target blocks.

9. The method according to claim 6, wherein the reference blocks of the second image block are specified based on information included in a header of the second image block.

10. The method according to claim 4, wherein the predetermined weights are calculated based on both the number of samples connected between the second image block and the target blocks and energy of the target blocks.

11. The method according to claim 7, wherein the predetermined weights are calculated based on both the number of samples connected between the first image block and the target blocks and energy of the target blocks.
